(19) United States
(12) Patent Application Publication
(10) Pub. No.: US 2024/0412041 A1
(43) Pub. Date: Dec. 12, 2024

(54) METHOD AND SYSTEM FOR NATURAL LANGUAGE TO POSE RETRIEVAL AND NATURAL LANGUAGE CONDITIONED POSE GENERATION

(71) Applicants: Naver Corporation, Seongnam-si (KR); Naver Labs Corporation, Seongnam-si (KR)

(72) Inventors: Ginger Delmas, Meylan (FR); Philippe Weinzaepfel, Montbonnot-Saint-Martin (FR); Thomas Lucas, Meylan (FR); Francesc Moreno-noguer, Meylan (FR); Gregory Rogez, Meylan (FR)

(73) Assignees: Naver Corporation, Seongnam-si (KR); Naver Labs Corporation, Seongnam-si (KR)

(21) Appl. No.: 18/376,030

(22) Filed: Oct. 3, 2023

Related U.S. Application Data
(60) Provisional application No. 63/471,539, filed on Jun. 7, 2023.

(51) Int. Cl. G06N 3/0455; G06F 40/58

(52) U.S. Cl. CPC G06N 3/0455; G06F 40/58

(57) ABSTRACT

A method and system for automatically building a three-dimensional pose dataset for use in text to pose retrieval or text to pose generation for a class of poses includes (a) inputting three-dimensional keypoint coordinates of class-centric poses; (b) extracting, from the inputted three-dimensional keypoint coordinates of class-centric poses, posecodes, the posecodes representing a relation between a specific set of joints; (c) selecting extracted posecodes to obtain a discriminative description; (d) aggregating selected posecodes that share semantic information; (e) converting the aggregated posecodes by electronically obtaining individual descriptions by plugging each posecode information into one template sentence, picked at random from a set of possible templates for a given posecode category; (f) concatenating the individual descriptions in random order, using random pre-defined transitions; and (g) mapping the concatenated individual descriptions to class-centric poses to create the three-dimensional pose dataset for the class of poses.

### PRIORITY INFORMATION

The present application claims priority, under 35 USC § 119(e), from U.S. Provisional Patent Application, Ser. No. 63/471,539, filed on Jun. 7, 2023. The entire content of U.S. Provisional Patent Application, Ser. No. 63/471,539, filed on Jun. 7, 2023, is hereby incorporated by reference.

### BACKGROUND

Natural language is leveraged in many tasks of computer vision such as image captioning, cross-modal retrieval, or visual question answering, to provide fine-grained semantic information. While human pose, or other classes of poses, is key to human understanding, conventional three-dimensional (3D) human pose datasets lack detailed language descriptions.

For example, if a text describes a downward dog yoga pose, a reader is able to picture such a pose from this natural language description. However, as noted above, conventional three-dimensional (3D) human pose datasets lack detailed language descriptions to enable the input of this text and retrieve a pose corresponding to the pose pictured by the reader.

While the problem of combining language and images or videos has attracted significant attention, in particular with the impressive results obtained by the recent multimodal neural networks CLIP and DALL-E, the problem of linking text and 3D geometry is largely unexplored.

There have been a few recent attempts at mapping text to rigid 3D shapes, and at using natural language for 3D object localization or 3D object differentiation. More recently, AIFit has been introduced, which is an approach to automatically generate human-interpretable feedback on the difference between a reference and a target motion.

There have also been a number of attempts to model humans using various forms of text. Attributes have been used for instance to model body shape and face images. Others leverage textual descriptions to generate motion, but without fine-grained control of the body limbs.

For example, a conventional process exploits the relation between two joints along the depth dimension.

Another conventional process describes human 3D poses through a series of posebits, which are binary indicators for different types of questions such as ‘Is the right hand above the hips?’ However, these types of Boolean assertions have limited expressivity and remain far from the natural language descriptions a human would use.

Being able to automatically map natural language descriptions and accurate 3D human poses would open the door to a number of applications: for helping image annotation when the deployment of Motion Capture (MoCap) systems is not practical; for performing semantic searches in large-scale datasets, which are currently only based on high-level metadata such as the action being performed for complex pose or motion data generation in digital animation; or for teaching basic posture skills to visually impaired individuals.

Therefore, it is desirable to provide a method or system that appropriately links text and 3D geometry of a human pose.

It is further desirable to provide a method or system that appropriately annotates images of 3D human poses.

It is also desirable to provide a method or system that performs semantic searches for 3D human poses.

Additionally, it is desirable to provide a method or system that uses natural language for 3D human pose retrieval.

Furthermore, it is desirable to provide a method or system that uses natural language to generate 3D human poses.

### BRIEF DESCRIPTION OF THE DRAWINGS

The drawings are only for purposes of illustrating various embodiments and are not to be construed as limiting, wherein:

FIG. 1 illustrates some examples of pose descriptions from PoseScript;

FIG. 2 is an overview of a captioning pipeline;

FIG. 3 illustrates an overview of a training scheme of a retrieval model;

FIG. 4 illustrates a table showing text-to-pose and pose-to-text retrieval results;

FIG. 5 illustrates an overview of a text-conditioned generative model;

FIG. 6 illustrates an example of text-to-pose retrieval;

FIG. 7 is an example of text-conditioned pose generation;

FIG. 8 is a table showing evaluation of the text-conditioned generative model;

FIG. 9 is a table showing a list of elementary posecodes;

FIG. 10 is a table showing conditions for posecode categorizations;

FIG. 11 is a graphical representation of categorizations of angle posecodes;

FIGS. 12 through 14 are graphical representations of categorizations of distance posecodes;

FIG. 15 is a graphical representation of categorizations of relative position posecodes along the y-axis

FIG. 16 is a graphical representation of categorizations of relative position posecodes along the x-axis;

FIGS. 17 and 18 are graphical representations of categorizations of relative position posecodes along the y-axis;

FIGS. 19 and 20 are graphical representations of categorizations of relative position posecodes along the z-axis;

FIGS. 21 and 22 are graphical representations of categorizations of pitch & roll posecodes;

FIG. 23 is a graphical representation of categorizations of ground contact posecodes;

FIG. 24 illustrates histograms showing a number of posecodes used per caption;

FIG. 25 illustrates histograms showing a number of words per automatic caption;

FIG. 26 is a table showing a list of super posecodes;

FIG. 27 is a table showing a summary of automatic caption versions;

FIG. 28 is a table showing text-to-pose and pose-to-text retrieval results; and

FIG. 29 illustrates an example of architecture in which the disclosed methods may be performed.

### DETAILED DESCRIPTION

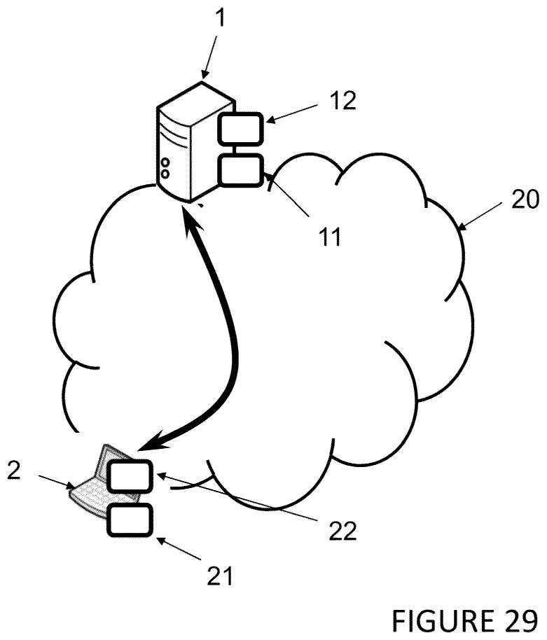

The described methods are implemented within an architecture such as illustrated in FIG. 29, by means of a server 1 and/or a client 2. Each of these devices 1, 2 are typically connected thanks to an extended network 20 such as the Internet for data exchange. Each one comprises data processors 11, 21, and optionally memory 12, 22 such as a hard disk.

In the various embodiments described below, a PoseScript dataset is used, which pairs (maps) a few thousands 3D human poses from AMASS with arbitrarily complex structural descriptions, in natural language, of the body parts and their spatial relationships.

To increase the size of this dataset to a scale compatible with typical data hungry methods, an elaborate captioning process has been used that generates automatic synthetic descriptions in natural language from given 3D keypoints. This process extracts low-level pose information—the posecodes—using a set of simple but generic rules on the 3D keypoints.

The posecodes are then combined into higher level textual descriptions using syntactic rules. Automatic annotations substantially increase the amount of available data, and make it possible to effectively pretrain deep models for finetuning on human captions.

As will be discussed in more detail below, the PoseScript dataset can be used in retrieval of relevant poses from large-scale datasets or synthetic pose generation, both based on a textual pose description.

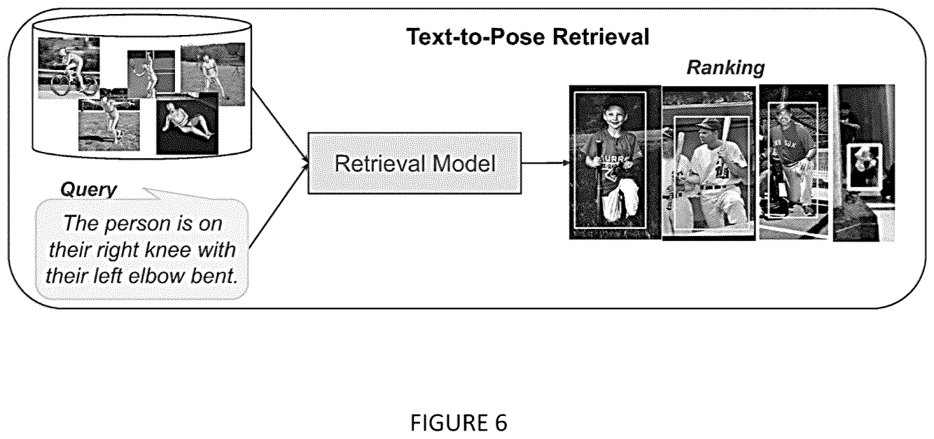

For example, as illustrated in FIG. 6, the PoseScript dataset can be used with text-to-pose retrieval where the goal is to retrieve poses in a large-scale database given a text query.

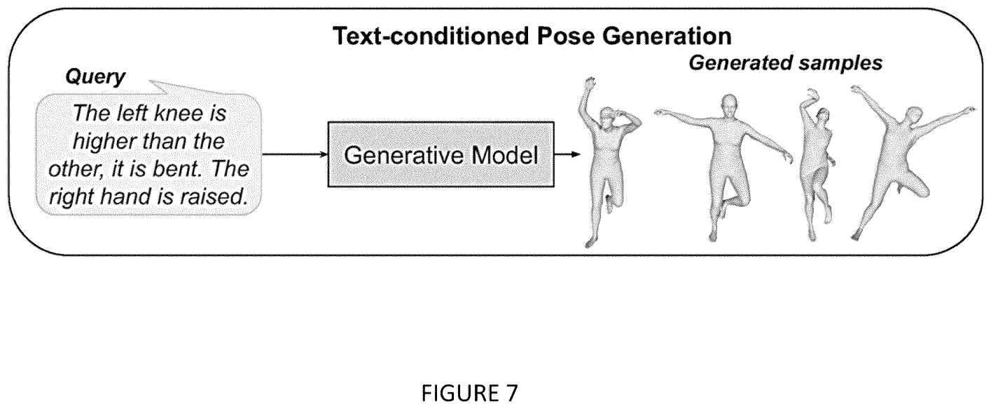

The PoseScript dataset can be used, as illustrated in FIG. 7, text-conditioned pose generation for complex pose or motion data generation in digital animation or teaching basic posture skills to visually impaired individuals.

As will be discussed in more detail below, the method and system maps 3D human poses with arbitrarily complex structural descriptions, in natural language, of the body parts and their spatial relationships using the PoseScript dataset, which is built using an automatic captioning pipeline for human-centric poses that makes it possible to annotate thousands of human poses in a few minutes. In other embodiments, the PoseScript dataset may be built using an automatic captioning pipeline for other class-centric poses that correspond to other classes of animals with expressive poses (e.g., dogs, cats, etc.) or classes of robotic machines with expressive poses (e.g., humanoid robots, robot quadrupeds, etc.).

The automatic captioning pipeline is built on (a) low-level information obtained via an extension of posebits to finer-grained categorical relations of the different body parts (e.g. ‘the knees are slightly/relatively/completely bent’), units that are referred to as posecodes, and on (b) higher-level concepts that come either from the action labels annotated by the BABEL (Bodies, Action and Behavior with English Labels) dataset, or combinations of posecodes.

Rules are defined to select and aggregate posecodes using linguistic aggregation rules, and convert them into sentences to produce textual descriptions. As a result, automatic extraction of human-like captions for a normalized input 3D pose is realized.

Additionally, since the process is randomized, several descriptions per pose can be generated, as different human annotators would do.

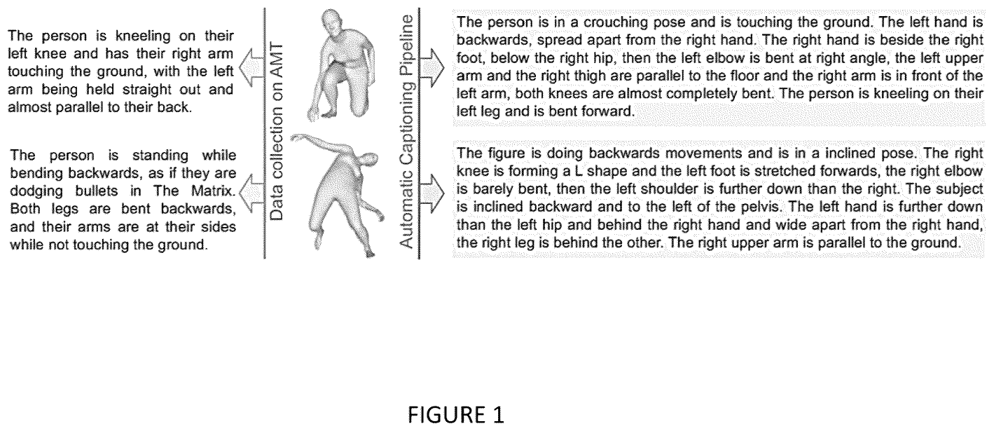

FIG. 1 shows examples of human-written and automatic captions. As illustrated in FIG. 1, examples of pose descriptions from PoseScript, produced by human annotators are shown on the left for the poses shown in the middle. Examples of pose descriptions from PoseScript produced by the automatic captioning pipeline are shown on the right for the poses shown in the middle.

Using the PoseScript dataset, as noted above and illustrated in FIG. 6, a cross-modal retrieval task can be performed where the goal is, given a text query, to retrieve the most similar poses in a database. Note that this can also be applied to RGB images by associating them with 3D human fits.

Also, using the PoseScript dataset, as noted above and illustrated in FIG. 7, a second task can be performed consisting of generating human poses (e.g., of a 3D model of the human body exhibiting a pose) conditioned on a textual description.

Conventional models have used attributes as semantic-level representation to edit body shapes or image faces. In contrast, the method and system, described below, focuses on body poses and leverages natural language, which has the advantage of being unconstrained and more flexible.

For example, one conventional method focuses on generating human 2D poses, SMPL (Skinned Multi-Person Linear 3D model) parameters or even images from captions. However, the captions, which are generally simple image-level statements on the activity performed by the human, and that sometimes account for the interaction with other elements from the scene, e.g. ‘A soccer player is running while the ball is in the air.’

In contrast, the method and system, described below, focuses on fine-grained detailed captions about the pose only (e.g., are not dependent on the activity of the scene in which a pose is taking place).

Another conventional method provides manually annotated captions about the difference between human poses in two synthetic images, wherein the captions mention objects from the environment such as ‘carpet’ or ‘door.’ A further conventional method automatically generates text about the discrepancies between a reference motion and a performed one, based on differences of angles and positions.

In contrast, the method and system, described below, focuses on describing one single pose without relying on any other visual element.

The method and system, described below, focuses on static poses, whereas many conventional methods have essentially studied 3D action (sequence) recognition or text-based 2D or 3D motion synthesis and either condition their model on action labels or descriptions in natural language. However, even if motion descriptions effectively constrain sequences of poses, motion descriptions do not specifically inform about individual poses.

The method and system, described below, uses a captioning generation process that relies on posecodes that capture relevant information about the pose semantics. Posecodes are inspired from posebits where images showing a human are annotated with various binary indicators. This data is used to reduce ambiguities in 3D pose estimation.

Conversely, the method and system, described below, automatically extract posecodes from normalized 3D poses in order to generate descriptions in natural language. Ordinal depth can be seen as a special case of posebits, focusing on the depth relationship between two joints to obtain annotations on some training images to improve a human mesh recovery model by adding extra constraints.

Poselets can also be used as another way to extract discriminative pose information but poselets lack semantic interpretations.

In contrast to these semantic representations, the method and system, described below, generate pose descriptions in natural language, which have the advantage (a) of being a very intuitive way to communicate ideas, and (b) of providing greater flexibility.

In the method and system, described below, the PoseScript dataset differs from existing datasets in that it focuses on single 3D poses instead of motion and provides direct descriptions in natural language instead of simple action labels, binary relations, or modifying texts.

The PoseScript dataset, as described below, is composed of static 3D human poses, together with fine-grained semantic annotations in natural language. The PoseScript dataset is built using automatically generated captions.

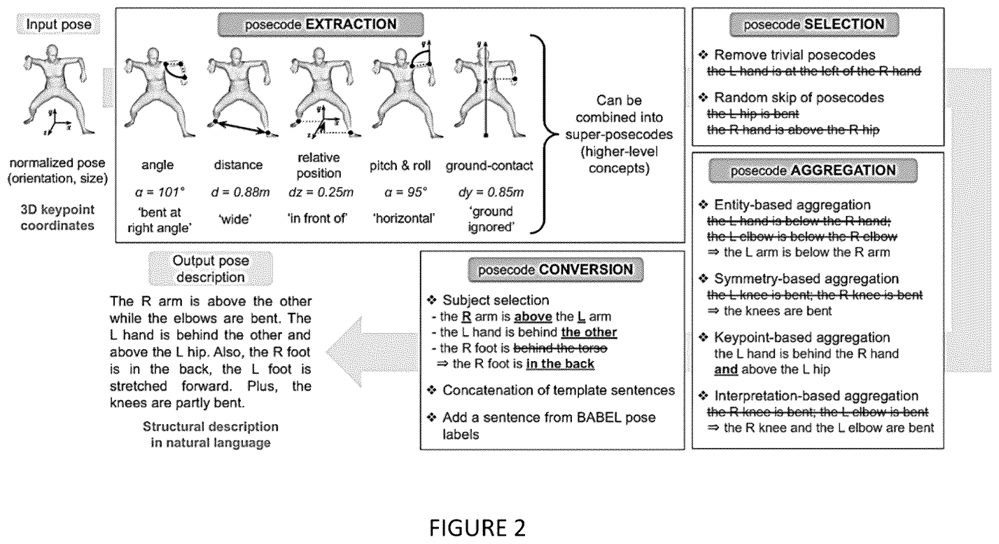

The process used to generate synthetic textual descriptions for 3D human poses (automatic captioning pipeline) is illustrated in FIG. 2. As illustrated in FIG. 2, the automatic captioning pipeline relies on the extraction, selection, and aggregation of elementary pieces of pose information, called posecodes, which are eventually converted into sentences to produce a description.

As illustrated in FIG. 2, given a normalized 3D pose, posecodes are used to extract semantic pose information. These posecodes are then selected, merged, or combined (when relevant) before being converted into a structural pose description in natural language. In FIG. 2, the letters ‘L’ and ‘R’ stand for ‘left’ and ‘right’ respectively.

The process, illustrated in FIG. 2, takes 3D keypoint coordinates of human-centric poses as input. These may be inferred with the SMPL-H body and hand model (i.e., a 3D (three dimensional) model of the human body based on skinning and blend shapes) using the default shape coefficients and a normalized global orientation along the y-axis.

With respect to the posecode extraction, as illustrated in FIG. 2, a posecode describes a relation between a specific set of joints. In one embodiment, the process captures for each specific set of joints five kinds of elementary relations: angles, distances and relative positions, but also pitch and roll and ground-contacts.

With respect to the posecode extraction, as illustrated in FIG. 2, angle posecodes describe how a body part ‘bends’ at a given joint, e.g. the left elbow. Depending on the angle, the posecode is assigned one of the following attributes: ‘straight’, ‘slightly bent’, ‘partially bent’, ‘bent at right angle’, ‘almost completely bent’ and ‘completely bent’.

With respect to the posecode extraction, as illustrated in FIG. 2, distance posecodes categorize the L2-distance between two keypoints (e.g. the two hands) into ‘close’, ‘shoulder width apart’, ‘spread’ or ‘wide’ apart.

With respect to the posecode extraction, as illustrated in FIG. 2, posecodes on relative position compute the difference between two keypoints along a given axis. The possible categories are, for the x-axis: ‘at the right of’, ‘x-ignored’, ‘at the left of’; for the y-axis: ‘below’, ‘y-ignored’, ‘above’; and for the z-axis: ‘behind’, ‘z-ignored’ and ‘in front of’. In particular, comparing the x-coordinate of the left and right hands allows to infer if they are crossed (i.e. the left hand is ‘at the right’ of the right hand). The ‘ignored’ interpretations are ambiguous configurations which will not be described.

With respect to the posecode extraction, as illustrated in FIG. 2, pitch & roll posecodes assess the verticality or horizontality of a body part defined by two keypoints; e.g., the left thigh is between the left knee and hip. A body part is ‘vertical’ if it is approximately orthogonal to the y-hyperplane, and ‘horizontal’ if it is in it. Other configurations are ‘pitch-roll-ignored’.

With respect to the posecode extraction, as illustrated in FIG. 2, ground-contact posecodes, used for intermediate computation only, denote whether a keypoint is ‘on ground’ (i.e. vertically close to the keypoint of minimal height in the body, considered as the ground) or ‘ground-ignored’.

Posecode categorizations are obtained using predefined thresholds. As these values are inherently subjective, the process randomizes the binning (i.e., categorization) step by also defining a noise level applied to the measured angles and distances values before thresholding.

The process additionally defines a few super-posecodes to extract higher-level pose concepts. These posecodes are binary (they either apply or not to a given pose configuration), and are expressed from elementary posecodes. For instance, the super-posecode ‘kneeling’ can be defined as having both knees ‘on the ground’ and ‘completely bent’.

As utilized in FIG. 2, posecode selection aims at selecting an interesting subset of posecodes among those extracted, to obtain a concise yet discriminative (i.e., distinguishable) description of the relations between joints. First, the process removes trivial settings (e.g. ‘the left hand is at the left of the right hand’). Next, the process randomly skips a few non-essential; i.e., non-trivial but non-highly discriminative; posecodes (e.g., ‘the left hip is bent’ or the right hand is above the right hip’), to account for the natural oversights made by humans. Such posecodes are determined through a statistical study over the whole set of poses, as will be discussed in more detail below. Also, the process sets highly-discriminative posecodes as unskippable. Lastly, the process removes some redundant posecodes by considering ripple effect; e.g., if ‘A is above C,’ ‘B is above C,’ and ‘A is above B’, ‘A is above B’ and ‘B is above C’ are kept.

As utilized in FIG. 2, posecode aggregation consists of merging together posecodes that share semantic information. This reduces the size of the caption and makes it more natural. The process uses four aggregation rules.

The first rule is entity-based aggregation, which merges posecodes that have similar relation attributes while describing keypoints that belong to a larger entity (e.g. the arm or the leg). For instance ‘the left hand is below the right hand’+‘the left elbow is below the right hand’ is combined into ‘the left arm is below the right hand’.

The second rule is symmetry-based aggregation which fuses posecodes that share the same relation attributes, and operate on joint sets that differ only by their side of the body. The joint of interest is hence put in plural form, e.g. ‘the left elbow is bent’+‘the right elbow is bent’ becomes ‘the elbows are bent’.

The third rule is keypoint-based aggregation which brings together posecodes with a common keypoint. The process factors the shared keypoint as the subject and concatenates the descriptions. The subject can be referred to again using e.g. ‘it’ or ‘they’. For instance, ‘the left elbow is above the right elbow’+‘the left elbow is close to the right shoulder’+‘the left elbow is bent’ is aggregated into ‘The left elbow is above the right elbow, and close to the right shoulder. It is bent.’

The last rule is interpretation-based aggregation which merges posecodes that have the same relation attribute, but applies to different joint sets (that may overlap). Conversely to entity-based aggregation, interpretation-based aggregation does not require that the involved keypoints belong to a shared entity. For instance, ‘the left knee is bent’+‘right elbow is bent’ becomes ‘the left knee and the right elbow are bent’.

Aggregation rules are applied at random when their conditions are met. In particular, joint-based and interpretation-based aggregation rules may operate on the same posecodes. To avoid favoring one rule over the other, merging options are first listed together and then applied at random.

As utilized in FIG. 2, posecode conversion into sentences is performed in two steps. First, the process selects the subject of each posecode. For symmetrical posecodes—which involve two joints that only differ by their body side—the subject is chosen at random between the two keypoints, and the other is randomly referred to by its name, its side or ‘the other’ to avoid repetitions and provide more varied captions. For asymmetrical posecodes, the process defines a ‘main’ keypoint (chosen as subject) and ‘support’ keypoints, used to specify pose information (e.g. the ‘head’ in ‘the left hand is raised above the head’). For the sake of flow, in some predefined cases, the process omits to name the support keypoint (e.g. ‘the left hand is raised above the head’ is reduced to ‘the left hand is raised’).

Second, the process combines all posecodes together in a final aggregation step. The process obtains individual descriptions by plugging each posecode information into one template sentence, picked at random in the set of possible templates for a given posecode category.

Finally, the process concatenates the pieces in random order, using random pre-defined transitions. Optionally, for poses extracted from annotated sequences in the BABEL dataset, the process adds a sentence based on the associated high-level concepts (e.g. ‘the person is in a yoga pose’).

Some automatic captioning examples are presented in FIG. 1 (right side). The captioning process is highly modular; it allows simply defining, selecting, and aggregating of the posecodes based on different rules. Design of new kinds of posecodes (especially super-posecodes) or additional aggregation rules, can yield further improvements. Randomization has been included at each step of the pipeline which makes it possible to generate different captions for the same pose, as a form of data augmentation.

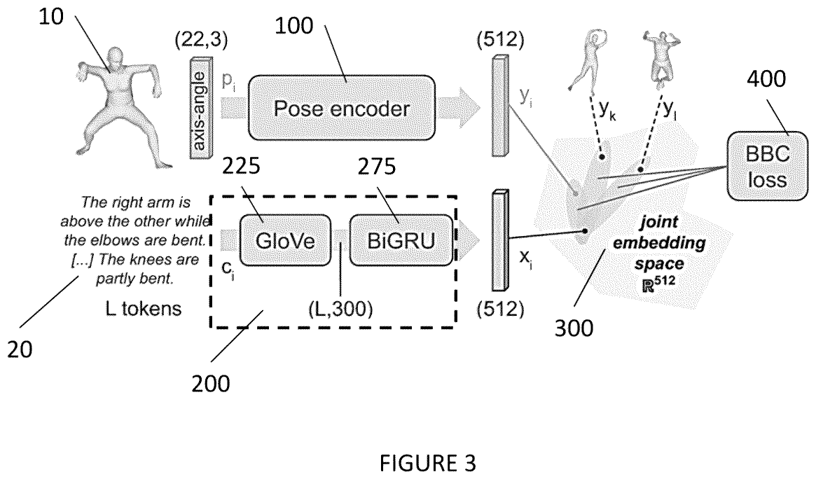

FIG. 3 illustrates an overview of a training scheme of a retrieval model. As illustrated in FIG. 3, the input pose 10 and caption 20 are fed to a pose encoder 100 and a text encoder 200, respectively, to map them into a joint embedding space 300. The loss 400 encourages the pose embedding yᵢ and its caption embedding xi to be close in this latent space 300, while being pulled apart from features of other poses in the same training batch (e.g. yₖ and yᵢ).

For text-to-pose retrieval, which consists in ranking a large collection of poses by relevance to a given textual query (and likewise for pose-to-text retrieval), it is standard to encode the multiple modalities into a common latent space.

Let S={(cᵢ, pᵢ)}^{N}ᵢ₌₁ be a set of caption-and-pose pairs. By construction, pᵢ is the most relevant pose for caption cᵢ, which means that p_{j≠i} should be ranked after pᵢ for text-to-pose retrieval. In other words, the retrieval model aims to learn a similarity function s(c, p)∈R such that s(cᵢ, pᵢ)>s(cᵢ, p_{j≠i}). As a result, a set of relevant poses can be retrieved for a given text query by computing and ranking the similarity scores between the query and each pose from the collection (the same goes for pose-to-text retrieval).

Since poses (e.g., 3D models of the human body exhibiting poses) and captions (e.g., text captions of describing poses of the human body) are from two different modalities, the process first uses modality-specific encoders to embed the inputs into a joint embedding space, where the two representations will be compared to produce the similarity score.

Let θ(⋅) and ϕ(⋅) be the textual and pose encoders respectively. The process denotes as x=θ(c)∈R^{d} and y=ϕ(p)∈R^{d} the L2-normalized representations of a caption c and of a pose p in the joint embedding space, as illustrated in FIG. 3.

As illustrated in FIG. 3, the tokenized caption 20 is embedded by a bi-GRU 275 mounted on top of pre-trained GloVe word embeddings 225

The pose 10 is first encoded as a matrix of size (22, 3), consisting of the rotation of the main 22 body joints in axis-angle representation. The pose is then flatten and fed as input to the pose encoder 100; e.g., a VPoser encoder; consisting of a 2-layer MLP with 512 units, batch normalization and leaky-ReLU, followed by a fully-connected layer of 32 units. The process adds a ReLU and a final projection layer, in order to produce an embedding of the same size d as the text encoding.

For training, given a batch of B training pairs (xᵢ, yᵢ), the process uses the Batch-Based Classification (BBC) loss (400), which is common in cross-modal retrieval.

$${ℒ}_{BBC} = - \frac{1}{B} {\sum }_{i = 1}^{B} log \frac{exp ( γ σ ( {x}_{i} , {y}_{i} ) )}{{\sum }_{j} exp ( γ σ ( {x}_{i} , {y}_{j} ) )} ,$$

where γ is a learnable temperature parameter and σ is the cosine similarity function σ(x, y)=x^{T}y/(∥x∥₂×∥y∥₂).

In implementing the training, the training used embeddings of size d=512 and an initial loss temperature of γ=10. GloVe word embeddings are 300-dimensional. The model was trained end to end for 120 epochs, using Adam, a batch size of 32 and an initial learning rate of 2.104 with a decay of 0.5 every 10 epochs.

Text-to-pose retrieval was evaluated by ranking the whole set of poses for each of the query texts. The recall@K (R@K), which is the proportion of query texts for which the corresponding pose is ranked in the top-K retrieved poses, was then computed. The pose-to-text retrieval was evaluated in a similar manner. K=1, 5, 10 was used and additionally report the mean recall (mRecall) as the average over all recall@K values from both retrieval directions.

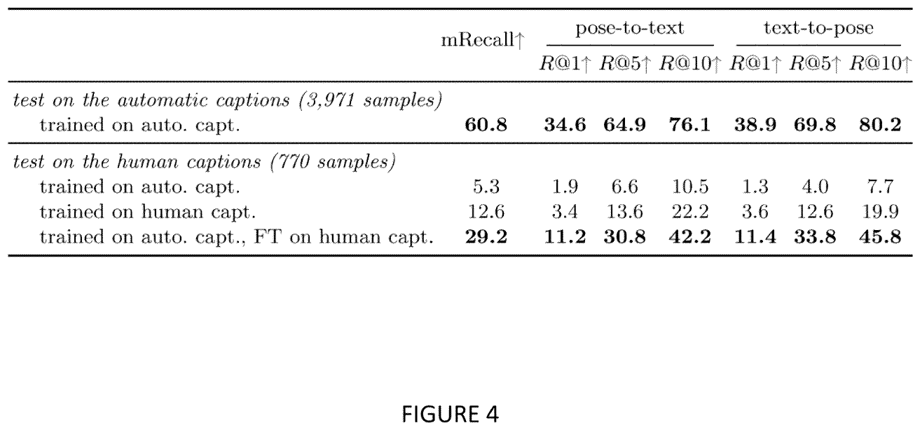

The results on the test set of PoseScript is illustrated in the table of FIG. 4 both on automatic and human-written captions only. As shown in the table, the model trained on automatic captions obtains a mean recall of 60.8%, with a R@1 above one third and a R@10 above 75% on automatic captions. However, the performance degrades on human captions, as many words from the richer human vocabulary are unseen during training on automatic captions.

When trained on human captions, the model obtains a higher—but still rather low—performance. Using human captions to finetune the initial model trained on automatic ones brings an improvement of a factor 2 and more, with a mean recall (resp. R@10 for text-to-pose) of 29.2% (resp. 45.8%) compared to 12.6% (resp. 19.9%) when training from scratch.

The evaluation shows the benefit of using the automatic captioning pipeline to scale-up the PoseScript dataset. In particular, the model is able to derive new concepts in human-written captions from non-trivial combination of existing posecodes in automatic captions.

With respect to text-conditioned human pose generation, i.e., generate possible matching poses for a given text query, the model is based on Variational Auto-Encoders (VAEs).

With respect to training, the process generates a pose \dot{p} given its caption c. To this end, a conditional VAE model is trained by taking a tuple (p, c) composed of a pose p and its caption c, at training.

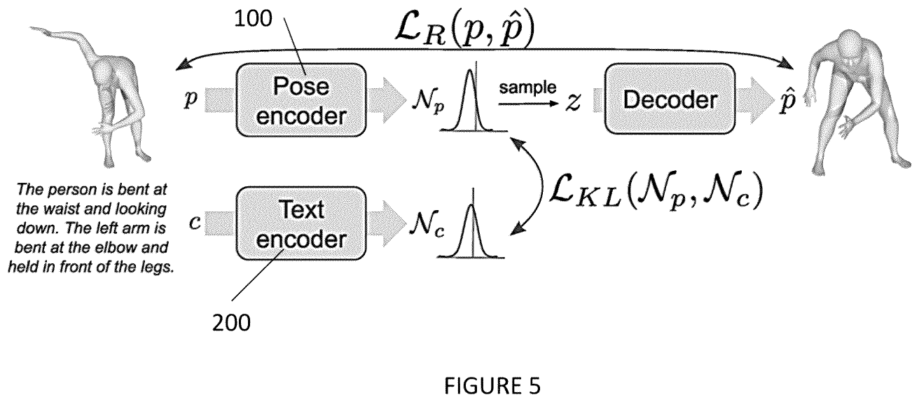

FIG. 5 illustrates an overview of the training model. As illustrated in FIG. 5, a pose encoder 100 maps the pose p to a posterior over latent variables by producing the mean μ(p) and variance Σ(p) of a normal distribution Nₚ=N(⋅|μ(p), Σ(p)).

Another encoder 200 is used to obtain a prior distribution independent of p but conditioned on c, N_{c}. A latent variable z˜Nₚ is sampled from Nₚ, and decoded into a generated sample pose \dot{p}. The training loss function combines a reconstruction term L_{R}(p, \dot{p}) between the original pose p and the generated pose \dot{p} and a regularization term, the Kullback-Leibler (KL) divergence between Nₚ and the prior given by N_{c}:

$$L = {L}_{R} ( p , \dot{p} ) + {L}_{KL} ( {N}_{p} , {N}_{c} ) .$$

As illustrated in FIG. 5, during training, the process follows a VAE but where the latent distribution Nₚ from the pose encoder has a KL divergence term with the prior distribution N_{c} given by the text encoder. At test time, the sample z is drawn from the distribution N_{c}. To sample from the model at test time, a caption c is encoded into N_{c}, from which z is sampled and decoded into a generated pose \dot{p}.

In training, the models use Adam optimizer with a learning rate of 10⁻⁴ and a weight decay of 10⁻⁴. The process follows VPoser for the pose encoder and decoder architectures, and use the same text encoder as in the retrieval training. The latent space has dimension 32.

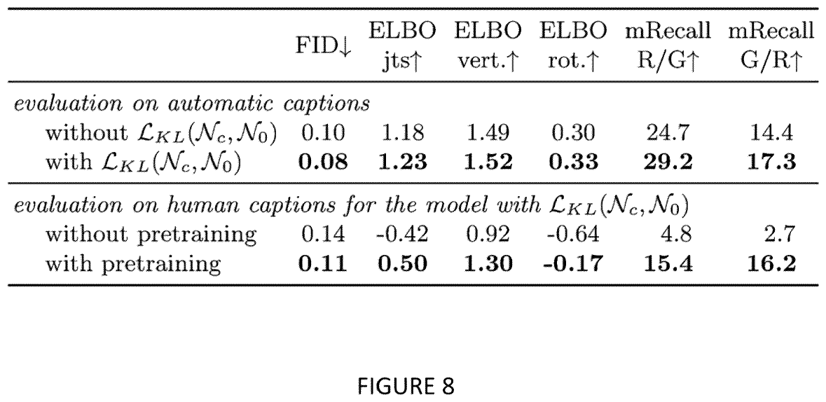

FIG. 8 illustrates a table showing evaluation of the text-conditioned generative model on automatic captions for a model without or with L_{KL}(N_{c}, N₀) (top) and on human captions without or with pre-training on the automatic captions (bottom). For comparison, the mRecall obtained when training and testing on real poses is 60.8 with automatic captions and 29.2 on human captions.

With respect to the table in FIG. 8, initially the impact of adding the extra-regularization loss L_{KL}(N_{c}, N₀) to the model when training and evaluating on automatic captions was studied. It was observed that it improves all metrics, in terms of FID, ELBO or mRecall retrieval metrics.

This configuration was kept and evaluated on human captions (a) when training on human captions and (b) when first pre-training on automatic captions and then finetuning on human captions. It was observed that the pre-training improves all metrics. In particular, the retrieval training/testing and the ELBOs improve substantially which shows that the pre-training helps to yield more realistic and diverse samples.

In the above described embodiments, angle posecodes describe how a body part ‘bends’ around a joint j. Let a set of keypoints (i, j, k) where i and k are neighboring keypoints to j—for instance left shoulder, elbow and wrist respectively—and let pl denote the position of keypoint l. The angle posecode is computed as the cosine similarity between vectors vji=pi−pj and vjk=pk−pj.

Moreover, in the above described embodiments, distance posecodes rate the L2-distance ∥vij∥ between two keypoints i and j.

Additionally, in the above described embodiments, posecodes on relative position compute the difference between two sets of coordinates along a specific axis, to determine their relative positioning. A keypoint i is ‘at the left of’ another keypoint j if p^{x}ᵢ>p^{x}ⱼ; it is ‘above’ it if py i>p^{y}ⱼ; and ‘in front of’ it if p^{z}ᵢ>p^{z}ⱼ.

Furthermore, in the above described embodiments, pitch & roll posecodes assess the verticality or horizontality of a body part defined by two keypoints i and j. A body part is said to be ‘vertical’ if the cosine similarity between vij/_∥vij∥ and the unit vector along the y-axis is close to 0. A body part is said to be ‘horizontal’ if it is close to 1.

Lastly, in the above described embodiments, ground-contact posecodes can be seen as specific cases of relative positioning posecodes along the y axis. Ground-contact posecodes help determine whether a keypoint i is close to the ground by evaluating p^{y}i−minⱼ p^{y}ⱼ. As not all poses are semantically in actual contact with the ground, the process does not resort to these posecodes for systematic description, but solely for intermediate computations, to further infer super-posecodes for specific pose configurations.

As described above, each type of posecode is first associated to a value v (a cosine similarity angle or a distance), then binned into categories using predefined thresholds. In practice, hard deterministic thresholding is unrealistic as two different persons are unlikely to always have the same interpretation when the values are close to category thresholds, e.g. when making the distinction between ‘spread’ and ‘wide’. Thus the categories are inherently ambiguous and to account for this human subjectivity, the process randomizes the binning step by defining a tolerable noise level η_{τ} on each threshold τ. The process then categorizes the posecode by comparing v+ϵ to τ, where ϵ is randomly sampled in the range [−η_{τ}, η_{τ}]. Hence, a given pose configuration does not always yield the exact same posecode categorization.

Super-posecodes are binary, and are not subject to the binning step. Super-posecodes only apply to a pose if all of the elementary posecodes they are based on possess the respective required posecode categorization.

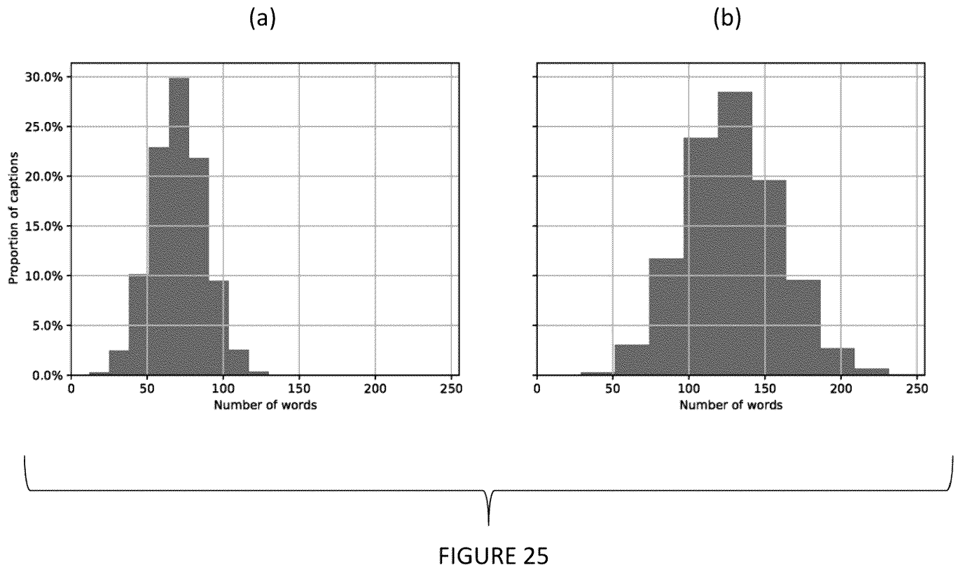

FIG. 26 illustrates a table showing a list of super-posecodes. For each super-posecode, the table indicates which body part(s) are subject to description and their corresponding pose configuration (each super-posecode is given a unique category). The table additionally specifies whether the associated posecode is skippable for description. The filled in circle represents an unskippable posecode and the filled in square represents a skippable posecode.

The last column explains the different options for the super-posecode to be produced (an option is represented by a set of elementary posecodes with their required categorization). Letters ‘L’ and ‘R’ stand for ‘left’ and ‘right,’ respectively.

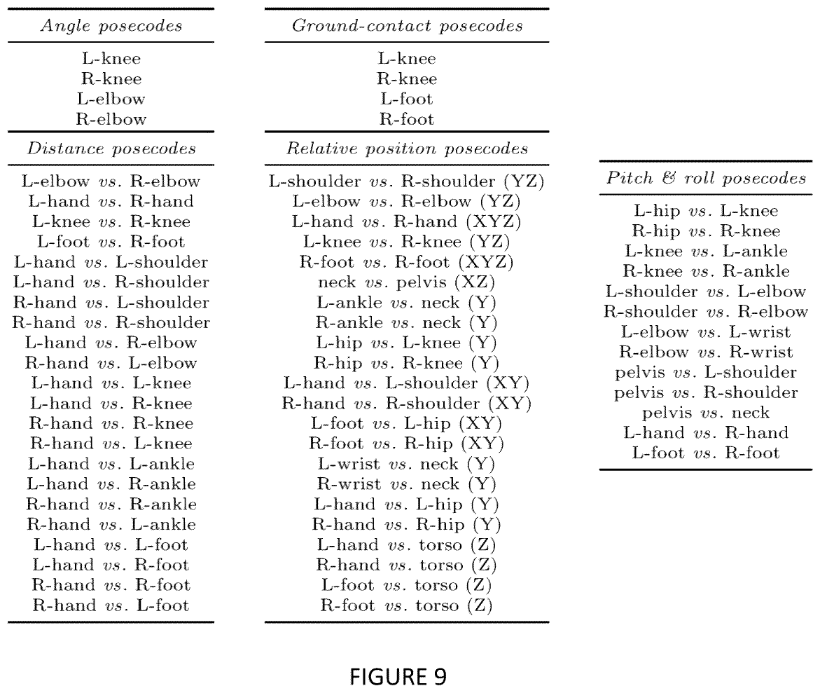

FIG. 9 provides a table listing the elementary posecodes that are used the above described embodiments. The list includes 4 angle posecodes, 22 distance posecodes, 34 posecodes describing relative positions (7 along the x-axis, 17 along the y-axis and 10 along the z-axis), 13 pitch & roll posecodes and 4 ground-contact posecodes.

The table provides the keypoints involved in each of the posecodes. The posecodes on relative positions are grouped for better readability, as some keypoints are studied along several axes (considered axes are indicated in parenthesis). Letters ‘L’ and ‘R’ stand for ‘left’ and ‘right,’ respectively.

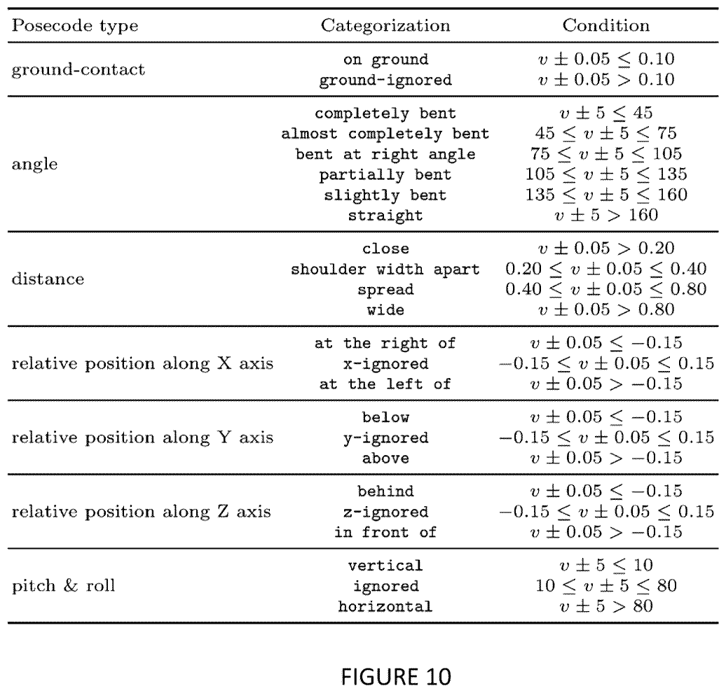

FIG. 10 illustrates a table conditions for posecode categorizations. The right column provides the condition for a posecode to have the categorization indicated in the middle column. v represents the estimated value (an angle converted in degrees, or a distance in meters), while the number after the ±denotes the maximum noise value that can be added to v. Thresholds and noise levels depend only on the type of posecode.

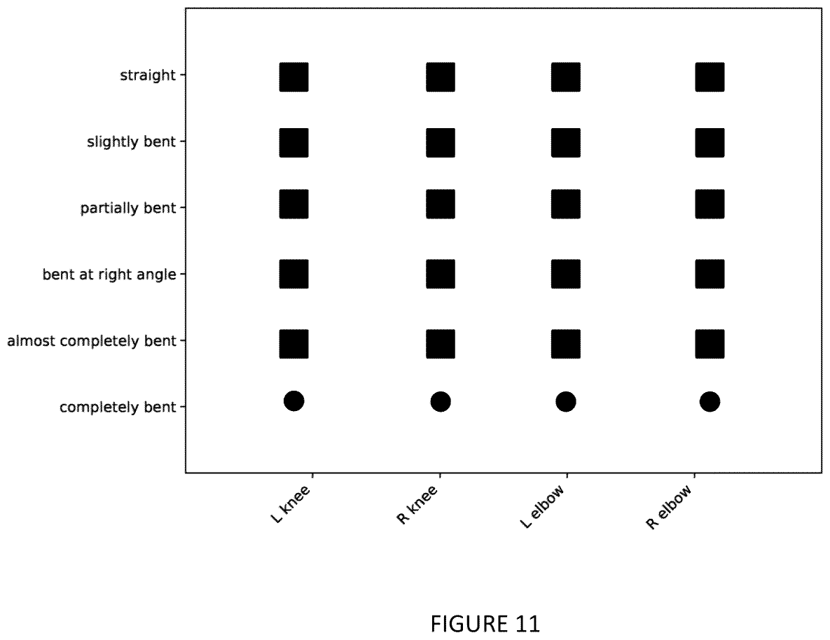

FIG. 11 illustrates angle posecode categorizations used at captioning time. Letters ‘L’ and ‘R’ refer to left and right body parts, respectively. The filled in circle represents an unskippable angle posecode categorization and the filled in square represents a skippable angle posecode categorization.

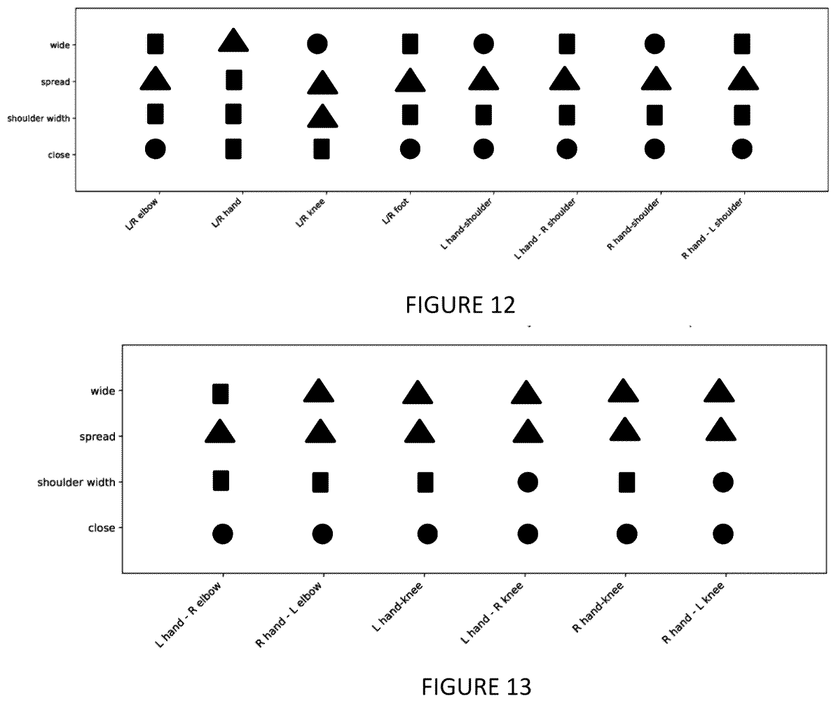

FIGS. 12 through 14 illustrate distance posecode categorizations used at captioning time. Letters ‘L’ and ‘R’ refer to left and right body parts, respectively. The filled in circle represents an unskippable distance posecode categorization, the filled in square represents a skippable distance posecode categorization, and the filled in triangle represents an ignored distance posecode categorization.

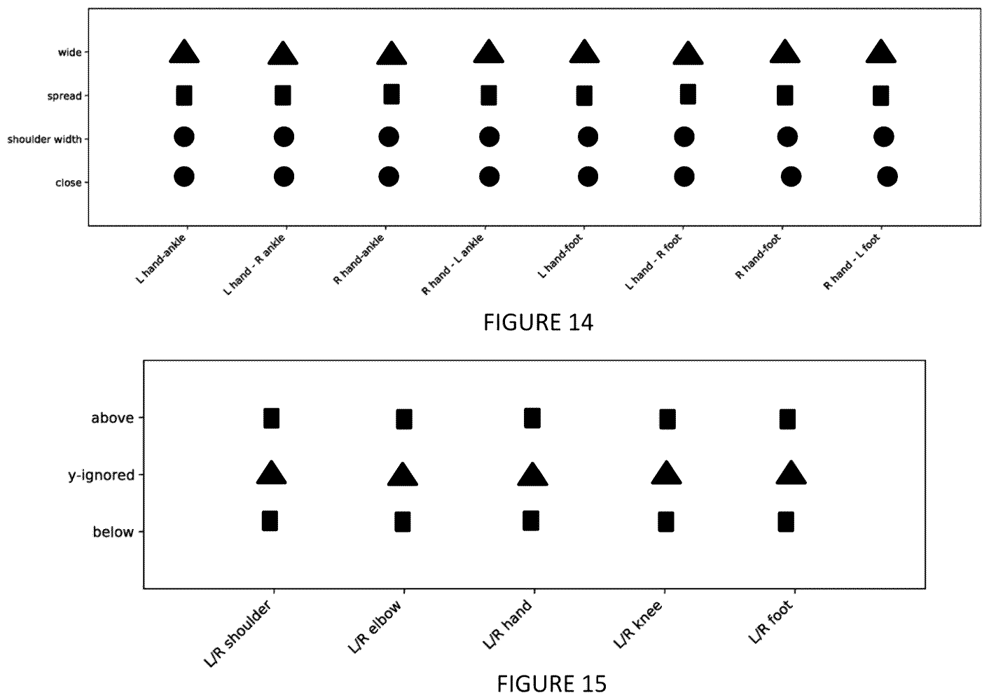

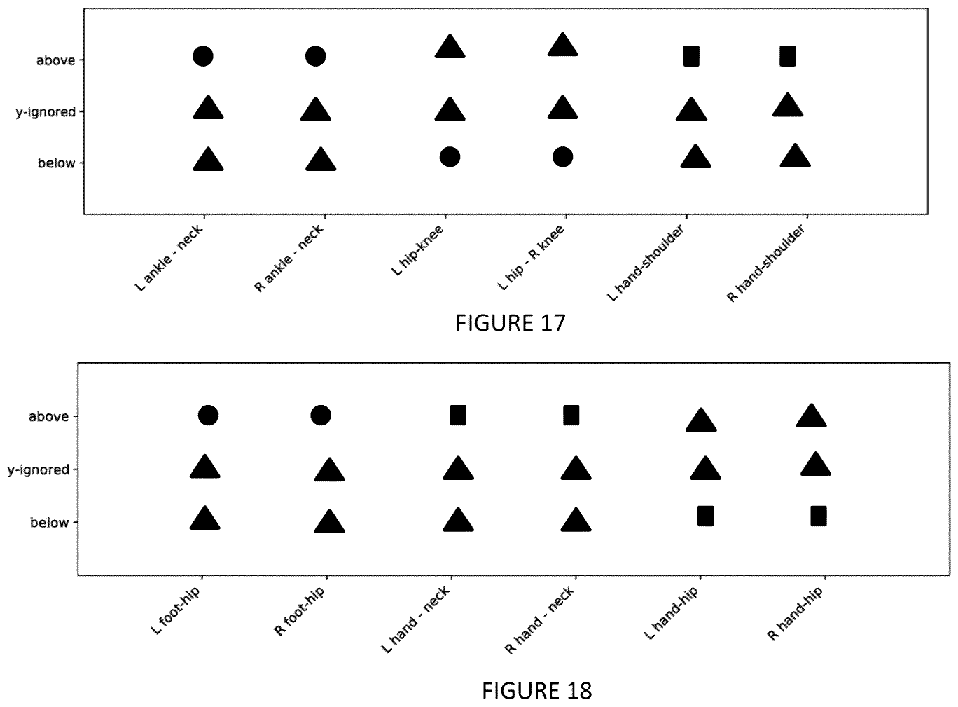

FIGS. 15, 17, and 18 illustrate relative position posecode categorizations along the y-axis. Letters ‘L’ and ‘R’ refer to left and right body parts, respectively. The filled in circle represents an unskippable relative position posecode categorization, the filled in square represents a skippable relative position posecode categorization, and the filled in triangle represents an ignored relative position posecode categorization.

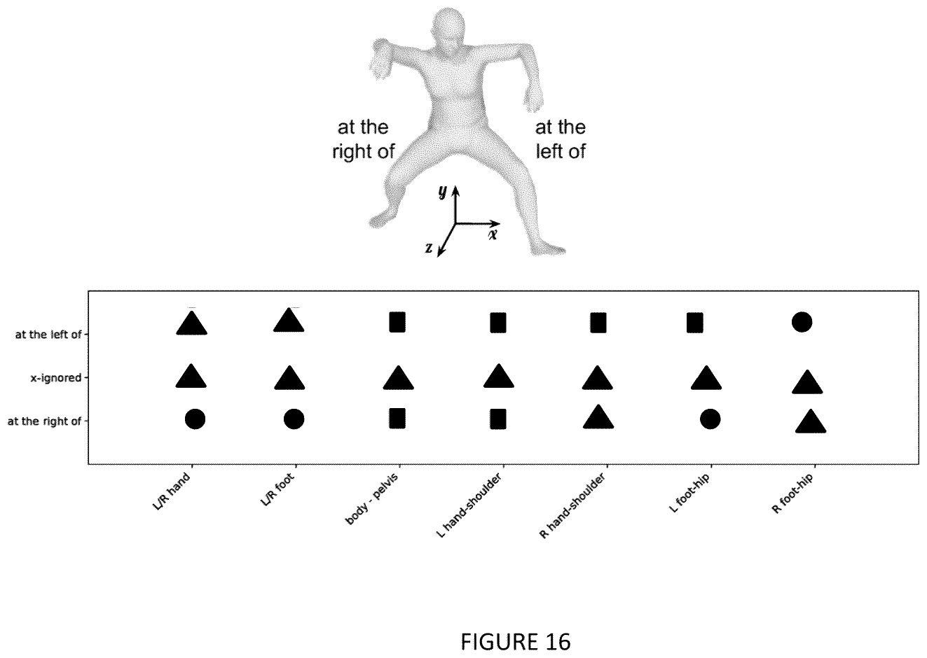

FIG. 16 illustrates relative position posecode categorizations along the x-axis. Letters ‘L’ and ‘R’ refer to left and right body parts, respectively. The filled in circle represents an unskippable relative position posecode categorization, the filled in square represents a skippable relative position posecode categorization, and the filled in triangle represents an ignored relative position posecode categorization.

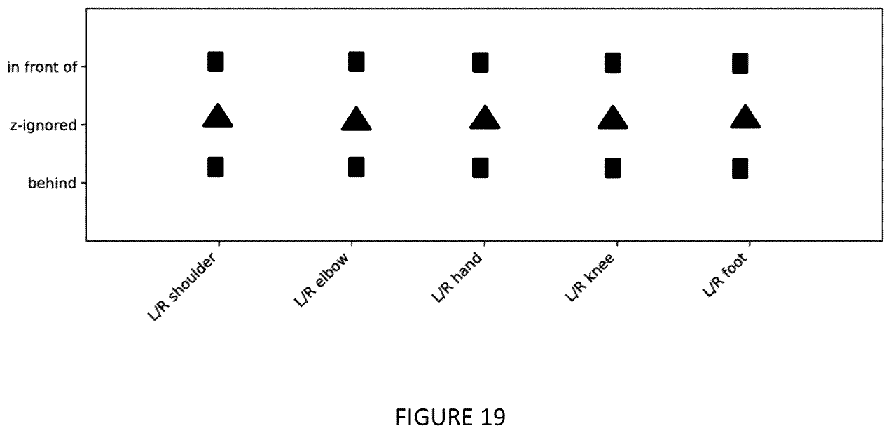

FIGS. 19 and 20 illustrate relative position posecode categorizations along the z-axis. Letters ‘L’ and ‘R’ refer to left and right body parts, respectively. The filled in circle represents an unskippable relative position posecode categorization, the filled in square represents a skippable relative position posecode categorization, and the filled in triangle represents an ignored relative position posecode categorization.

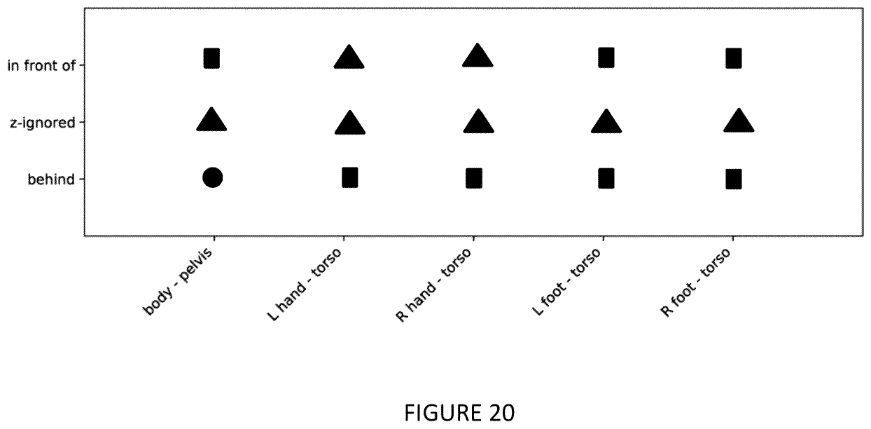

FIGS. 21 and 22 illustrate pitch & roll posecode categorizations. Letters ‘L’ and ‘R’ refer to left and right body parts, respectively. The filled in circle represents an unskippable pitch & roll posecode categorization, the filled in square represents a skippable pitch & roll posecode categorization, and the filled in triangle represents an ignored pitch & roll posecode categorization.

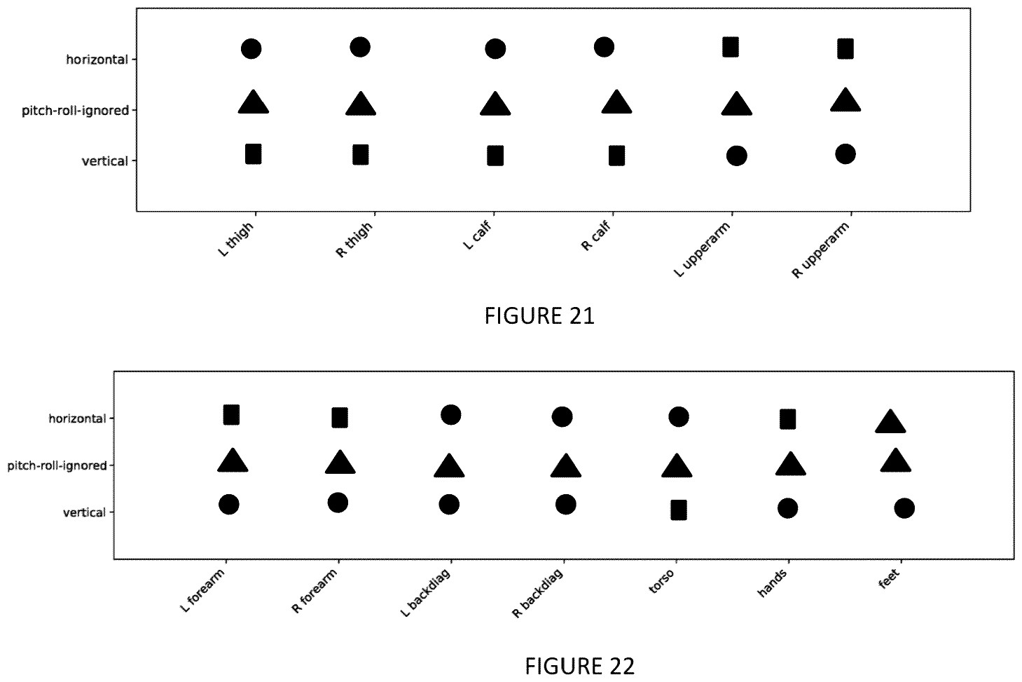

FIG. 23 illustrates ground-contact posecode categorizations. Letters ‘L’ and ‘R’ refer to left and right body parts, respectively. The filled in circle represents an unskippable ground-contact posecode categorization, the filled in square represents a skippable ground-contact posecode categorization, and the filled in triangle represents an ignored ground-contact posecode categorization.

The following is an explanation of a process used to generate 5 automatic captions for each pose and report retrieval performance when pre-training on each of them and evaluating on human-written captions. The explanation will also include statistics about the captioning process and provide additional information about certain steps of the captioning process.

In the process, all 5 captions, for each pose, were generated with the same pipeline. However, in order to propose captions with slightly different characteristics, some steps of the process were disabled when producing the different versions. Specifically, steps that were deactivated include (1) randomly skipping eligible posecodes for description; (2) adding a sentence constructed from high-level pose annotations given by the BABEL dataset; (3) aggregating posecodes; (4) omitting support keypoints (e.g. ‘the right foot is behind the torso’ does not turn into ‘the right foot is in the back’ when this step is deactivated); and (5) randomly referring to a body part by a substitute word (e.g. ‘it’/‘they’, ‘the other’).

In order to ease apart the impact of each step, the process defined, as ‘simplified captions,’ a variant of the procedure in which none of the last 3 steps were applied during the generation process.

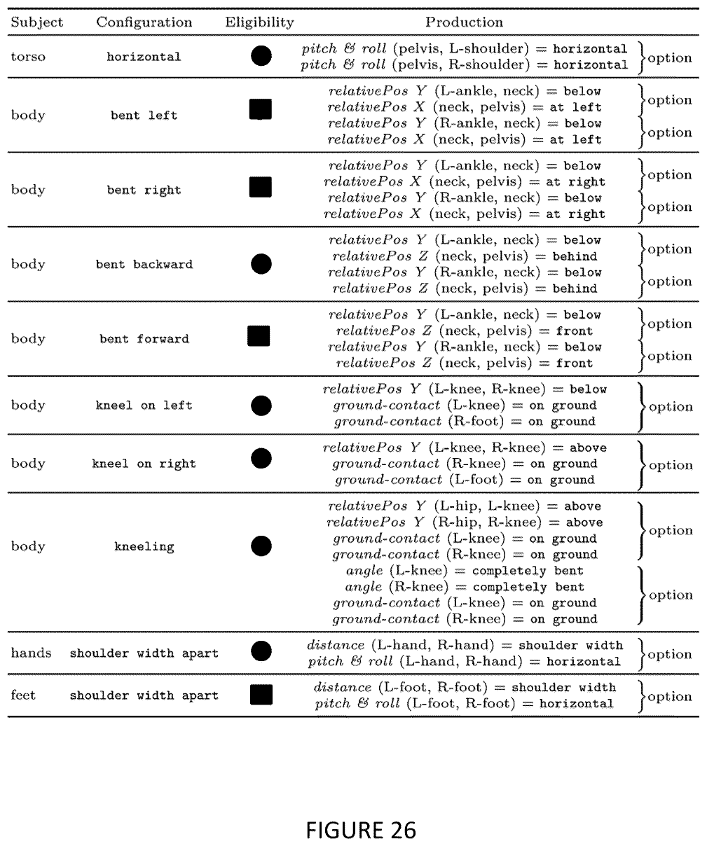

Among all the poses of PoseScript, only 6,628 are annotated in the BABEL dataset and may benefit from an additional sentence in their automatic description. As 39% of PoseScript poses come from DanceDB, which was not annotated in the BABEL dataset, the process additionally assign the ‘dancing’ label to those DanceDB-originated poses, for one variant of the automatic captions that already leverages the BABEL dataset auxiliary annotations (See the table of FIG. 27). This resulted in 14,435 poses benefiting from an auxiliary label.

FIG. 27 illustrates a table showing a summary of the automatic caption versions. The V symbols indicate when characteristics apply to each caption version.

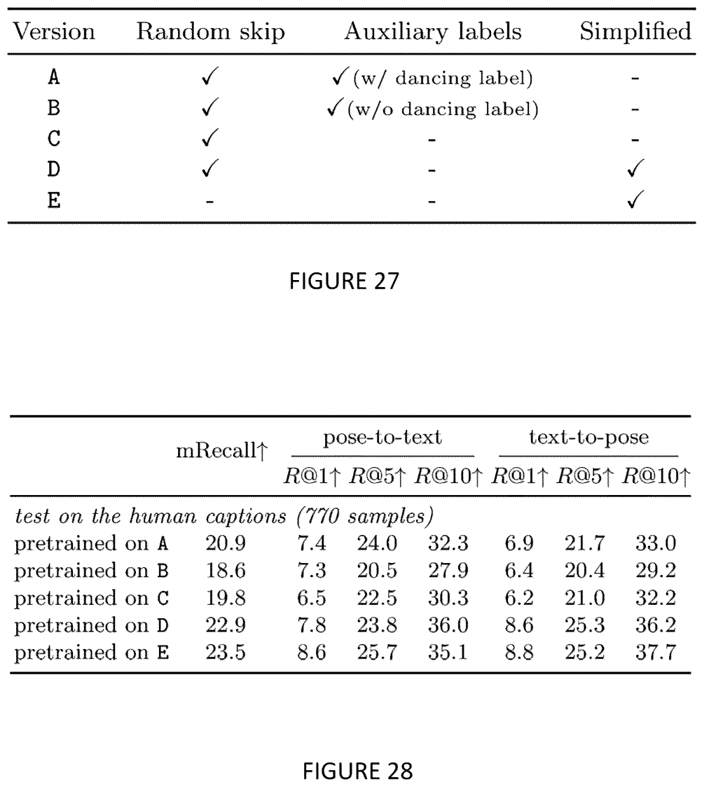

FIG. 28 illustrates a table showing the retrieval performance on human-written captions when pre-training a retrieval model on each automatic caption version separately, then fine-tuning the models on human-written captions before evaluation.

More specifically, the table of FIG. 28 shows text-to-pose and pose-to-text retrieval results on the test split of human-written captions from PoseScript dataset, when pre-training separately on each automatic caption version, then fine-tuning on human-written captions.

First, note that best retrieval results were obtained by pre-training on all five caption versions together (as illustrated in FIG. 4). It approximately obtains a 6 points improvement with respect to the best model trained on one single caption version.

Next, the impact of posecode aggregation and phrasing implicitness on retrieval performance is observed by comparing results obtained by pre-training either on caption version D or on caption version C. Both caption versions share the same characteristics, except that version D is ‘simplified’. This means that D captions do not contain pronouns such as ‘it’ and ‘the other’, which represent an inherent challenge in NLP, as a model needs to understand to which entity these pronouns refer.

Moreover, there is no omission of secondary keypoints (e.g. ‘the right foot is behind the torso’). Hence, D captions have much less phrasing implicitness than C captions (note that there is still implicit information in the simplified captions, e.g. ‘the right hand is close to the left hand’ implicitly involves some rotation at the elbow or shoulder level). In the table of FIG. 28, a mean-recall increase of 3% is observed when pre-training on D. This shows that aggregation and phrasing implicitness lead to more complex captions, as this is a source of error for cross-modal retrieval.

It is noted that the additional ‘dancing’ label for poses originated from DanceDB greatly helps (2.3 points improvement for A with respect to B). This may be because it makes it easier to distinguish between more casual poses (e.g. sitting) and highly various ones. Also, not using any BABEL label is better than using some, as evidenced by the 1.2 points difference between B and C. This can be explained by the fact that less than 33% of PoseScript poses are provided a BABEL label, and that those are too diverse (some examples include ‘yawning’, ‘coughing’, ‘applauding’, ‘golfing’ . . . ) and too rare to robustly learn from. Many of these labels are motion labels and thus do not discriminate specific static poses. Finally, it is noted that slightly better performance is obtained when not randomly skipping posecodes, possibly because descriptions that are more complete and precise are beneficial for learning.

A number of ‘eligible’ posecode categorizations were extracted from the 20,000 poses over the different caption versions. During the posecode selection process, 42,857 of these were randomly skipped. In practice, a bit less than 6% of the posecodes (17,593) are systematically kept for captioning due to being statistically discriminative (unskippable posecodes). All caption versions were generated together in less than 5 minutes for the whole PoseScript dataset. Since the pose annotation task usually takes 2-3 minutes, it means that 60 k descriptions can be generated in the time it takes to manually write one.

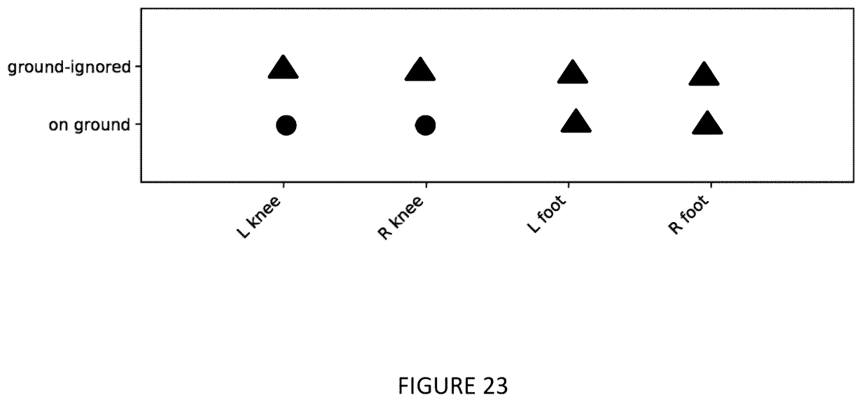

Histograms about the number of posecodes used to generate the captions are presented in FIG. 24 The histogram on the left presents the number of posecodes for the caption version E, which does not perform random skipping. The number of posecodes of each pose, in the right histogram, was averaged over the other 4 caption versions produced for it.

Automatic captions are based on an average number of 13.5 posecodes. Besides, it is noted that that less than 0.1% of the poses had the exact same set of 87 posecode categorizations than another.

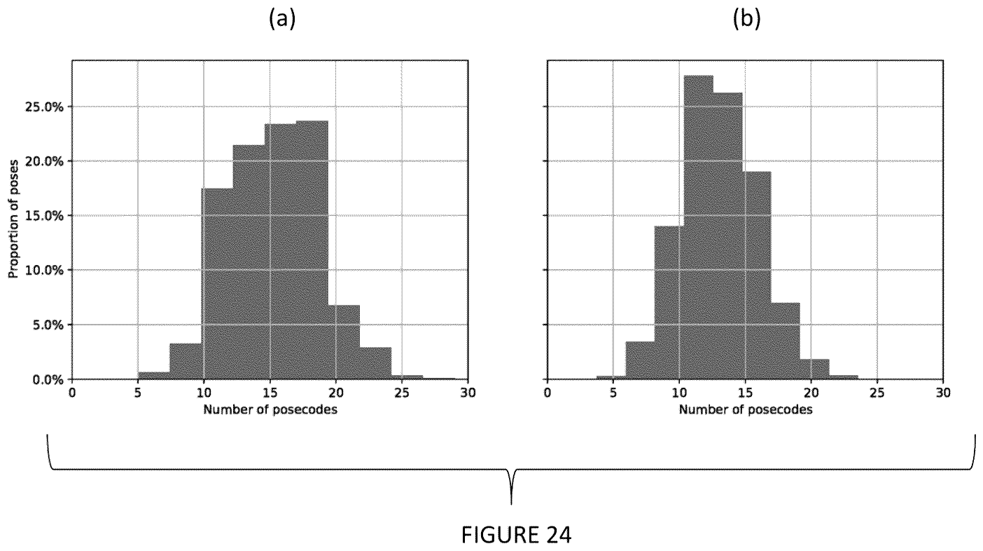

Histograms about the number of words per automatic caption are additionally shown in FIG. 25, for version C (left) and version E (right). The length difference can be explained by the fact that version C was obtained by randomly skipping some posecodes and generally aggregating them. Version C captions are assumed to be closer to what humans would write.

Note that removal of redundant posecodes is not yet performed in the posecode selection step of our automatic captioning pipeline. The automatic captions are hence naturally longer than human-written captions

The process takes 3D joint coordinates of human-centric poses as input. These are inferred using the neutral body shape with default shape coefficients and a normalized global orientation along the y-axis. The process uses the resulting pose vector of dimension N×3 (N=52 joints for the SMPL-H model), augmented with a few additional keypoints, such as the left/right hands and the torso. They are deduced by simple linear combination of the positions of other joints, and are included to ease retrieval of pose semantics (e.g. a hand is in the back if it is behind the torso).

Specifically, the hand keypoint is computed as the center between the wrist keypoint and the keypoint corresponding to the second phalanx of the hand's middle finger; and the torso keypoint is computed as the average of the pelvis, the neck, and the third spine keypoint.

For entity-based aggregation, two very simple entities are defined: the arm (formed by the elbow, and either the hand or the wrist; or by the upper-arm and the forearm) and the leg (formed by the knee, and either the foot or the ankle; or by the thigh and the calf).

With respect to omitting support keypoints, the process omits the second keypoint in the phrasing in those specific cases: a body part is compared to the torso, the hand is found ‘above’ the head, and the hand (resp. foot) is compared to its associated shoulder (resp. hip) and is found either cat the left of’ or cat the right of’ of it. For instance, better than having ‘the right hand is at the left of the left shoulder’, which is quite tiresome; e.g., would have ‘the right hand is turned to the left’.

In addition to generating dataset using an automatic process as discussed above, a portion of the dataset can be built using a human intelligence task wherein a person provides a written description of a given pose that is accurate enough to for the pose to be identified, based upon pose discriminators, from the other similar poses.

To select the pose discriminators for a given pose to be annotated, the pose discriminator for a given pose is compared to the other poses of PoseScript. Similarity between the poses is measured using the distance between their pose embeddings, with an early version of the retrieval model.

In one embodiment, discriminators may be the closest poses, while having at least twenty different posecode categorizations. This ensures that the selected poses share some semantic similarities with the pose to be annotated while having sufficient differences to be easily distinguished by the human annotator.

A human generated annotated pose is used when nearly all the body parts are described; there is no left/right confusion; the description refers to a static pose, and not to a motion; there is no distance metric; and there is no subjective comment regarding the pose.

A computer implemented method for building a three-dimensional pose dataset for use in text to pose retrieval or text to pose generation for a class of poses, comprises (a) electronically inputting three-dimensional keypoint coordinates of class-centric poses; (b) electronically extracting, from the inputted three-dimensional keypoint coordinates of class-centric poses, posecodes, the posecodes representing a relation between a specific set of joints; (c) electronically selecting extracted posecodes to obtain a discriminative description of relations between joints; (d) electronically aggregating selected posecodes that share semantic information; (e) electronically converting the aggregated posecodes by electronically obtaining individual descriptions by plugging each posecode information into one template sentence, picked at random from a set of possible templates for a given posecode category; (f) electronically concatenating the individual descriptions in random order, using random pre-defined transitions; and (g) electronically mapping the concatenated individual descriptions to class-centric poses to create the three-dimensional pose dataset for the class of poses.

The class of poses may be human poses and the extracted posecodes may be angle posecodes, distance posecodes, relative position posecodes, pitch and roll posecodes, and ground-contact posecodes.

The inputted three-dimensional keypoint coordinates of class-centric poses may be inferred with a three-dimensional model of the human body using default shape coefficients and a normalized global orientation along a y-axis.

The angle posecodes may describe how a body part ‘bends’ at a given joint; the distance posecodes may categorize the L2-distance between two keypoints; the relative position posecodes may compute the difference between two keypoints along a given axis; the pitch & roll posecodes may assess the verticality or horizontality of a body part defined by two keypoints; and the ground-contact posecodes may denote whether a keypoint is on ground.

The electronically selecting extracted posecodes may include electronically removing posecodes corresponding to trivial settings.

The electronically selecting extracted posecodes may include electronically randomly skipping non-essential posecodes, non-essential posecodes being non-trivial but non-highly discriminative.

The electronically may select extracted posecodes includes electronically not removing or skipping highly-discriminative posecodes.

The electronically aggregating selected posecodes may include merging posecodes that have similar relation attributes while describing keypoints that belong to a larger entity.

The electronically aggregating selected posecodes may include fusing posecodes that share same relation attributes, and operate on joint sets that differ only by their side of a body.

The electronically aggregating selected posecodes may include bringing together posecodes with a common keypoint by factoring shared keypoint as a subject and concatenates descriptions.

The electronically aggregating selected posecodes may include merging posecodes that have same relation attribute, but applying to different joint sets.

The electronically selecting extracted posecodes may include entity-based aggregation, symmetry-based aggregation, keypoint-based aggregation, and interpretation-based aggregation, the aggregations being applied at random when predetermined conditions are met.

A computer implemented method for training a text to pose retrieval model using a three-dimensional pose dataset for a class of poses, comprises (a) using the three-dimensional pose dataset, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and electronically mapping the concatenated individual descriptions to class-centric poses to create the three-dimensional pose dataset for the class of poses, to provide pose and caption; (b) electronically inputting pose and caption from the three-dimensional pose dataset for the class of poses; (c) electronically encoding the pose using a pose encoder; (d) electronically encoding the caption using a text encoder; and (e) electronically training the text to pose model for the class of poses using a loss.

The computer implemented method may further include (e1) electronically mapping the encoded pose and encoded text into a joint embedding space; and (e2) electronically training the text to pose retrieval model using Batch-Based Classification loss

$${ℒ}_{BBC} = - \frac{1}{B} {\sum }_{i = 1}^{B} log \frac{exp ( γ σ ( {x}_{i} , {y}_{i} ) )}{{\sum }_{j} exp ( γ σ ( {x}_{i} , {y}_{j} ) )} ,$$

where γ is a learnable temperature parameter and σ is the cosine similarity function σ(x, y)=x^{T}y/(∥x∥₂×∥y∥₂).

The electronically encoding the caption may be encoded a bi-GRU mounted on top of pre-trained GloVe word embeddings.

The pose may be encoded as a matrix consisting of the rotation of main body joints in axis-angle representation and flattened before being electronically encoded by the pose encoder.

The pose encoder may include a VPoser encoder; consisting of a 2-layer MLP, batch normalization and leaky-ReLU, followed by a fully-connected layer, a ReLU, and a projection layer.

A computer implemented method for training a text to pose generation model using a three-dimensional pose dataset for a class of poses, comprises (a) using the three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and electronically mapping the concatenated individual descriptions to class-centric poses to create the three-dimensional pose dataset for the class of poses, to provide pose and caption; (b) electronically inputting pose and caption from the three-dimensional pose dataset for the class of poses; (c) electronically encoding the pose using a pose encoder to create a latent distribution Nₚ; (d) electronically encoding the caption using a text encoder to create a text conditioned distribution N_{c}; (e) electronically generating a pose from a sample in the latent distribution; and (f) electronically training the a text to pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:

$$L = {L}_{R} ( p , \dot{p} ) + {L}_{K L} ( {N}_{p} , {N}_{c} ) .$$

The electronically encoding the pose may be encoded by mapping the inputted pose p to a posterior over latent variables by producing mean μ(p) and variance Σ(p) of a normal distribution Nₚ=N(⋅|μ(p), Σ(p)).

The latent distribution Nₚ from the pose encoder may have a KL divergence term with the text conditioned distribution N_{c}.

A computer implemented method for retrieving a three-dimensional pose from a text to pose retrieval model using natural language for a class of poses, comprises (a) electronically inputting a desired three-dimensional pose using natural language; (b) electronically retrieving, based on the inputted desired three-dimensional pose, a three-dimensional pose from a text to pose retrieval model, the text to pose retrieval model being trained using a three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and (c) electronically outputting the retrieved three-dimensional pose for the class of poses.

The class of poses may be human poses and the text to pose retrieval model may be trained by electronically inputting pose and caption from the three-dimensional pose dataset; electronically encoding the pose using a pose encoder; electronically encoding the caption using a text encoder; electronically mapping the encoded pose and encoded text into a joint embedding space; and electronically training the text to pose retrieval model using Batch-Based Classification loss

$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$

where γ is a learnable temperature parameter and σ is the cosine similarity function σ(x, y)=x^{T}y/(∥x∥₂×∥y∥₂).

The electronically encoding the caption may be encoded a bi-GRU mounted on top of pre-trained GloVe word embeddings.

The pose may be encoded as a matrix consisting of the rotation of main body joints in axis-angle representation and flattened before being electronically encoded by the pose encoder.

The pose encoder may include a VPoser encoder; consisting of a 2-layer MLP, batch normalization and leaky-ReLU, followed by a fully-connected layer, a ReLU, and a projection layer.

A computer implemented method for generating a three-dimensional pose from a text to pose generation model using natural language for a class of poses, comprises (a) electronically inputting a desired three-dimensional pose using natural language; (b) electronically generating, based on the inputted desired three-dimensional pose, a three-dimensional pose from the text to pose generation model, the text to pose generation model being trained using a three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description, electronically aggregating selected posecodes that share semantic information, electronically converting the aggregated posecodes by electronically obtaining individual descriptions by plugging each posecode information into one template sentence, picked at random from a set of possible templates for a given posecode category; and (c) electronically outputting the generated three-dimensional pose for the class of poses.

The class of poses may be human poses and the text to human pose generation model may be trained by electronically inputting pose and caption from the three-dimensional human pose dataset; electronically encoding the pose using a pose encoder to create a latent distribution Nₚ; electronically encoding the caption using a text encoder to create a text conditioned distribution N_{c}; electronically generating a pose from a sample in the latent distribution; and electronically training the a text to human pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:

$$L = {L}_{R} ( p , \dot{p} ) + {L}_{K L} ( {N}_{p} , {N}_{c} ) .$$

The electronically encoding the pose may be encoded by mapping the inputted pose p to a posterior over latent variables by producing mean μ(p) and variance Σ(p) of a normal distribution Nₚ=N(⋅|μ(p), Σ(p)).

The latent distribution Nₚ from the pose encoder may have a KL divergence term with the text conditioned distribution N_{c}.

A computer implemented method for training a text to pose model using a three-dimensional pose dataset for a class of poses, comprising (a) using the three-dimensional pose dataset, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and electronically mapping the concatenated individual descriptions to class-centric poses to create the three-dimensional pose dataset, to provide pose and caption; (b) electronically inputting pose and caption from the three-dimensional human pose dataset; (c) electronically encoding the pose using a pose encoder; (d) electronically encoding the caption using a text encoder; (e) electronically training the text to pose model for the class of poses using a loss.

The n the text to pose model mat be a retrieval model; and wherein (e) may further comprise (e1) electronically mapping the encoded pose and encoded text into a joint embedding space; and (e2) electronically training the text to pose retrieval model using Batch-Based Classification loss

$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$

where γ is a learnable temperature parameter and σ is the cosine similarity function σ(x, y)=x^{T}y/(∥x∥₂×∥y∥₂).

The text to pose model may be a generation model and wherein (c) may electronically encode the pose using the pose encoder to create a latent distribution Nₚ; (d) may electronically encode the caption using the text encoder to create a text conditioned distribution N_{c}; and (e) may further comprise (e1) electronically generating a pose from a sample in the latent distribution, and (e2) electronically training the text to pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:

$$L = {L}_{R} ( p , \dot{p} ) + {L}_{K L} ( {N}_{p} , {N}_{c} ) .$$

A computer implemented method for training a text to pose model, comprising (a) creating a three-dimensional pose dataset for a class of poses, the three-dimensional pose dataset for the class of poses being built by human intelligence tasks wherein a human generated written description of a given pose can be used to identify a pose, based upon pose discriminators, from the other similar poses; (b) electronically inputting pose and caption from the three-dimensional pose dataset; (c) electronically encoding the pose using a pose encoder; (d) electronically encoding the caption using a text encoder; (e) electronically training the text to pose model for the class of poses using a loss.

The three-dimensional pose dataset for the class of poses may be further created by (a1) electronically inputting three-dimensional keypoint coordinates of class-centric poses; (a2) electronically extracting, from the inputted three-dimensional keypoint coordinates of class-centric poses, posecodes, the posecodes representing a relation between a specific set of joints; (a3) electronically selecting extracted posecodes to obtain a discriminative description of relations between joints; (a4) electronically aggregating selected posecodes that share semantic information; (a5) electronically converting the aggregated posecodes by electronically obtaining individual descriptions by plugging each posecode information into one template sentence, picked at random from a set of possible templates for a given posecode category; (a6) electronically concatenating the individual descriptions in random order, using random pre-defined transitions; and (a7) electronically mapping the concatenated individual descriptions to class-centric poses to create the three-dimensional pose dataset for the class of poses.

The he text to pose model may be a retrieval model; and wherein (e) may further comprise (e1) electronically mapping the encoded pose and encoded text into a joint embedding space and (e2) electronically training the text to pose retrieval model using Batch-Based Classification loss

$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$

where γ is a learnable temperature parameter and σ is the cosine similarity function σ(x, y)=x^{T}y/(∥x∥₂×∥y∥₂).

The text to pose model may be a generation model; wherein (c) may electronically encode the pose using the pose encoder to create a latent distribution Nₚ; wherein (d) may electronically encode the caption using the text encoder to create a text conditioned distribution N_{c}; and wherein (e) may further comprise (e1) electronically generating a pose from a sample in the latent distribution and (e2) electronically training the text to pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:

$$L = {L}_{R} ( p , \dot{p} ) + {L}_{K L} ( {N}_{p} , {N}_{c} ) .$$

It will be appreciated that variations of the above-disclosed embodiments and other features and functions, and/or alternatives thereof, may be desirably combined into many other different systems and/or applications. Also, various presently unforeseen and/or unanticipated alternatives, modifications, variations, and/or improvements therein may be subsequently made by those skilled in the art which are also intended to be encompassed by the description above and the following claims.

1-16. (canceled)

17. A computer implemented method for training a text to pose model using a three-dimensional pose dataset for a class of poses, comprising:
(a) using the three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description of relations between joints, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and
electronically mapping the concatenated individual descriptions to class-centric poses to create the three-dimensional pose dataset, to provide pose and caption;
(b) electronically inputting pose and caption from the three-dimensional pose dataset;
(c) electronically encoding the pose using a pose encoder;
(d) electronically encoding the caption using a text encoder;
(e) electronically mapping the encoded pose and encoded text into a joint embedding space; and
(f) electronically training the text to pose model for the class of poses using a loss.

18. The method as claimed in claim 17, wherein the text to pose model is a retrieval model; and wherein (e) further comprises:
(e1) electronically mapping the encoded pose and encoded text into a joint embedding space; and
(e2) electronically training the text to pose retrieval model using Batch-Based Classification loss
$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$
where γ is a learnable temperature parameter and σ is the cosine similarity function σ(x, y)=x^{T}y/(∥x∥₂×∥y∥₂).

19. The method as claimed in claim 18, wherein (d) electronically encoding the caption is encoded a bi-GRU mounted on top of pre-trained GloVe word embeddings.

20. The method as claimed in claim 18, wherein the pose is encoded as a matrix consisting of the rotation of main body joints in axis-angle representation and flattened before being electronically encoded by the pose encoder.

21. The method as claimed in claim 18, wherein the pose encoder includes a VPoser encoder; consisting of a 2-layer MLP, batch normalization and leaky-ReLU, followed by a fully-connected layer, a ReLU, and a projection layer.

22. The method as claimed in claim 17, wherein the text to pose model is a generation model;
wherein (c) electronically encodes the pose using the pose encoder to create a latent distribution Nₚ;
wherein (d) electronically encodes the caption using the text encoder to create a text conditioned distribution N_{c}; and
wherein (e) further comprises:
(e1) electronically generating a pose from a sample in the latent distribution; and
(e2) electronically training the text to pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:
$$L = {L}_{R} ( p , \dot{p} ) + {L}_{K L} ( {N}_{p} , {N}_{c} ) .$$

23. The method as claimed in claim 22, wherein (b) electronically encoding the pose is encoded by mapping the inputted pose p to a posterior over latent variables by producing mean μ(p) and variance Σ(p) of a normal distribution Nₚ=N(⋅|μ(p), Σ(p)).

24. The method as claimed in claim 22, wherein the latent distribution Nₚ from the pose encoder has a KL divergence term with the text conditioned distribution N_{c}.

25. A method for retrieving a three-dimensional pose from a text to pose retrieval model using natural language for a class of poses, comprising:
(a) electronically inputting a desired three-dimensional pose using natural language;
(b) electronically retrieving, based on the inputted desired three-dimensional pose, a three-dimensional pose from a text to pose retrieval model trained using a three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description of relations between joints, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and electronically mapping the concatenated individual descriptions to class-centric poses to create the three-dimensional pose dataset for the class of poses; and
(c) electronically outputting the retrieved three-dimensional pose for the class of poses.

26. The method as claimed in claim 25, wherein the class of poses are human poses and the text to pose retrieval model is trained by electronically inputting pose and caption from the three-dimensional pose dataset for the class of poses; electronically encoding the pose using a pose encoder; electronically encoding the caption using a text encoder; electronically mapping the encoded pose and encoded text into a joint embedding space; and electronically training the text to pose retrieval model using Batch-Based Classification loss
$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$
where γ is a learnable temperature parameter and σ is the cosine similarity function σ(x, y)=x^{T}y/(∥x∥₂×∥y∥₂).

27. The method as claimed in claim 26, wherein electronically encoding the caption is encoded a bi-GRU mounted on top of pre-trained GloVe word embeddings.

28. The method as claimed in claim 26, wherein the pose is encoded as a matrix consisting of the rotation of main body joints in axis-angle representation and flattened before being electronically encoded by the pose encoder.

29. The method as claimed in claim 26, wherein the pose encoder includes a VPoser encoder; consisting of a 2-layer MLP, batch normalization and leaky-ReLU, followed by a fully-connected layer, a ReLU, and a projection layer.

30. A computer implemented method for generating a three-dimensional pose from a text to human pose generation model using natural language for a class of poses, comprising:
(a) electronically inputting a desired three-dimensional pose using natural language;
(b) electronically generating, based on the inputted desired three-dimensional pose using natural language, a three-dimensional pose from the text to pose generation model, the text to pose generation model being trained using a three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description of relations between joints, electronically aggregating selected posecodes that share semantic information, electronically converting the aggregated posecodes by electronically obtaining individual descriptions by plugging each posecode information into one template sentence, picked at random from a set of possible templates for a given posecode category, and electronically concatenating the individual descriptions in random order, using random pre-defined transitions; and
(c) electronically outputting the generated three-dimensional pose for the class of poses.

31. The method as claimed in claim 30, wherein the class of poses are human poses and the text to pose generation model is trained by electronically inputting pose and caption from the three-dimensional pose dataset for the class of poses; electronically encoding the pose using a pose encoder to create a latent distribution Nₚ; electronically encoding the caption using a text encoder to create a text conditioned distribution N_{c}; electronically generating a pose from a sample in the latent distribution; and electronically training the a text to human pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:
$$L = {L}_{R} ( p , \dot{p} ) + {L}_{K L} ( {N}_{p} , {N}_{c} ) .$$

32. The method as claimed in claim 31, wherein electronically encoding the pose is encoded by mapping the inputted pose p to a posterior over latent variables by producing mean μ(p) and variance Σ(p) of a normal distribution Nₚ=N(⋅|μ(p), Σ(p)).

33. The method as claimed in claim 31, wherein the latent distribution Nₚ from the pose encoder has a KL divergence term with the text conditioned distribution N_{c}.

34. A computer implemented method for training a text to pose model using a three-dimensional pose dataset for a class of poses, comprising:
(a) using the three-dimensional pose dataset for the class of poses, built by electronically inputting three-dimensional keypoint coordinates of class-centric poses, electronically extracting, from the inputted three-dimensional keypoint coordinates of class-centric poses, posecodes, the posecodes representing a relation between a specific set of joints, electronically selecting extracted posecodes to obtain a discriminative description of relations between joints, electronically aggregating selected posecodes that share semantic information, electronically converting the aggregated posecodes by electronically obtaining individual descriptions by plugging each posecode information into one template sentence, picked at random from a set of possible templates for a given posecode category, electronically concatenating the individual descriptions in random order, using random pre-defined transitions; and electronically mapping the concatenated individual descriptions to class-centric poses to create the three-dimensional pose dataset, to provide pose and caption;
(b) electronically inputting pose and caption from the three-dimensional human pose dataset;
(c) electronically encoding the pose using a pose encoder;
(d) electronically encoding the caption using a text encoder;
(e) electronically training the text to pose model for the class of poses using a loss.

35. The method as claimed in claim 34, wherein the text to pose model is a retrieval model; and wherein (e) further comprises:
(e1) electronically mapping the encoded pose and encoded text into a joint embedding space; and
(e2) electronically training the text to pose retrieval model using Batch-Based Classification loss
$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$
where γ is a learnable temperature parameter and σ is the cosine similarity function σ(x, y)=x^{T}y/(∥x∥₂×∥y∥₂).

36. The method as claimed in claim 34, wherein the text to pose model is a generation model;
wherein (c) electronically encodes the pose using the pose encoder to create a latent distribution Nₚ;
wherein (d) electronically encodes the caption using the text encoder to create a text conditioned distribution N_{c}; and
wherein (e) further comprises:
(e1) electronically generating a pose from a sample in the latent distribution; and
(e2) electronically training the text to pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:
$$L = {L}_{R} ( p , \dot{p} ) + {L}_{K L} ( {N}_{p} , {N}_{c} ) .$$

37. A computer implemented method for training a text to pose model, comprising:
(a) creating a three-dimensional pose dataset for a class of poses, the three-dimensional pose dataset for the class of poses being built by human intelligence tasks wherein a human generated written description of a given pose can be used to identify a pose, based upon pose discriminators, from the other similar poses;
(b) electronically inputting pose and caption from the three-dimensional pose dataset;
(c) electronically encoding the pose using a pose encoder;
(d) electronically encoding the caption using a text encoder;
(e) electronically training the text to pose model for the class of poses using a loss.

38. The method as claimed in claim 37, wherein the three-dimensional pose dataset for the class of poses is further created by
(a1) electronically inputting three-dimensional keypoint coordinates of class-centric poses;
(a2) electronically extracting, from the inputted three-dimensional keypoint coordinates of class-centric poses, posecodes, the posecodes representing a relation between a specific set of joints;
(a3) electronically selecting extracted posecodes to obtain a discriminative description of relations between joints;
(a4) electronically aggregating selected posecodes that share semantic information;
(a5) electronically converting the aggregated posecodes by electronically obtaining individual descriptions by plugging each posecode information into one template sentence, picked at random from a set of possible templates for a given posecode category;
(a6) electronically concatenating the individual descriptions in random order, using random pre-defined transitions; and
(a7) electronically mapping the concatenated individual descriptions to class-centric poses to create the three-dimensional pose dataset for the class of poses.

39. The method as claimed in claim 37, wherein the text to pose model is a retrieval model; and wherein (e) further comprises:
(e1) electronically mapping the encoded pose and encoded text into a joint embedding space; and
(e2) electronically training the text to pose retrieval model using Batch-Based Classification loss
$${ℒ}_{B B C} = - \frac{1}{B} {{\sum }_{i = 1}}^{B} log \frac{exp ( γ σ ( {x}_{i} , {y}_{i} ) )}{{\sum }_{j} exp ( γσ ( {x}_{i} , {y}_{j} ) )} ,$$
where γ is a learnable temperature parameter and σ is the cosine similarity function σ(x, y)=x^{T}y/(∥x∥₂×∥y∥₂).

40. The method as claimed in claim 37, wherein the text to pose model is a generation model;
wherein (c) electronically encodes the pose using the pose encoder to create a latent distribution Nₚ;
wherein (d) electronically encodes the caption using the text encoder to create a text conditioned distribution N_{c}; and
wherein (e) further comprises:
(e1) electronically generating a pose from a sample in the latent distribution; and
(e2) electronically training the text to pose generation model using a loss function, the loss function combining a reconstruction term L_{R}(p, \dot{p}) between the inputted pose p and the generated pose \dot{p} and a regularization term, the Kullback-Leibler (KL) divergence between the latent distribution Nₚ and the text conditioned distribution N_{c}:
$$L = {L}_{R} ( p , \dot{p} ) + {L}_{K L} ( {N}_{p} , {N}_{c} ) .$$
